(19) United States
(12) Patent Application Publication
(10) Pub. No.: US 2019/0318366 A1
(43) Pub. Date: Oct. 17, 2019

(54) METHODS AND APPARATUS FOR RESOLVING COMPLIANCE ISSUES

(71) Applicant: Intel Corporation, Santa Clara, CA (US)

(72) Inventors: Marcos Carranza, Portland, OR (US); Brian Cremeans, Hillsboro, OR (US); Krishna Surya, Portland, OR (US); Mats Agerstam, Portland, OR (US); Shengtian Zhou, Palo Alto, CA (US); Maria Ramirez Loaiza, Beaverton, OR (US); Cesar Martinez-Spessot, Cordoba (AR); Mohammad Mejbah ul Alam, Milpitas, CA (US); Dario Oliver, Hillsboro, OR (US); Justin Gottschlich, Santa Clara, CA (US)

(21) Appl. No.: 16/453,649

(22) Filed: Jun. 26, 2019

(51) Int. Cl. G06Q 30/00; G06F 16/28; G06N 20/00; G06N 5/04

(52) U.S. Cl. CPC G06Q 30/018; G06N 5/04; G06N 20/00; G06F 16/285

(57) ABSTRACT

An apparatus includes a feature extractor to extract features from input data, the features including descriptive information corresponding to a function of the input data, an inference generator to classify the features into a group indicative of a semantic property, a programming pattern, or a compliance type of the function of the input data, assign a cluster identifier to the features based on a prediction that the features are classified into the group, and retrieve solutions from a database that correspond to the cluster identifier, and a suggestion determiner to generate a suggestion list by building a pool of suggestions to present to a user.

### FIELD OF THE DISCLOSURE

This disclosure relates generally to compliance detection, and, more particularly, to resolving compliance issues.

### BACKGROUND

A compliance program is a set of internal policies and procedures utilized by a company to comply with laws, rules and regulations, or to uphold business reputation. Compliance tools are utilized when new software programs are introduced to a company by a developer designing the software for use in a system. For example, compliance tools may analyze the new software programs before implementation into a company's system to determine if the new software programs meet the compliance laws set forth by the company.

### BRIEF DESCRIPTION OF THE DRAWINGS

FIG. 1 is a block diagram of a compliance handing system to detect a compliance issue in a software project.

FIG. 2 is a block diagram of an example batch model updater of FIG. 1 to train a model to predict a category of a compliance issue.

FIG. 3 is a block diagram of an example compliance detector of FIG. 1 to detect a type of compliance issue and suggest an approach to fix the issue.

FIG. 4 is a flowchart representative of machine readable instructions which may be executed by a processor to implement the compliance handling system of FIG. 1.

FIG. 5 is a flowchart representative of machine readable instructions which may be executed by a processor to implement the example batch model updater of FIGS. 1 and 2.

FIG. 6 is a flowchart representative of machine readable instructions which may be executed by a processor to implement the example compliance detector of FIGS. 1 and 3.

FIG. 7 is a block diagram of an example processing platform structured to execute the instructions of FIGS. 4, 5, and 6 to implement the compliance handling system of FIG. 1.

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

In software engineering, a developer, software engineer, computer programmer, etc., generates software instructing a system how to operate. For example, a company may have a time tracking system for the company's employees to keep track of the hours they work in a week or a day. When a developer generates the software, the software must go through different phases of testing before the software can be implemented in the system. The phases of testing include compliance testing, unit testing, integration testing, system testing, and acceptance testing. The compliance test includes analyzing the software commit (e.g., a software commit is the new software function(s) making changes to the system and/or being added to the system) to determine if there is a licensing issue, a security issue, a privacy issue, an export control issue, and/or any other regulations and rules set forth by the company utilizing the system.

To test software commits for compliance, different tools run once a day or periodically to generate a build, depending on the number of software commits a developer uploads each day. For example, compliance tools cannot run each time a developer creates a new software commit due to time, computational inefficiency, and high costs. A software build is a process that converts the source code in software into a stand-alone form that can be run on a computer or to the form itself. One of the most important steps of a software build is the compilation process, where source code files are converted into executable code. Builds are created when a certain point in development has been reached or the software has been deemed ready for implementation, either for testing or outright release.

Compliance tools are too compute-heavy to run multiple times in a day because they require the use of large databases and/or external application programming interfaces (API) to compare functions of the software commit to functions in the databases corresponding to licensing issues, security issues, export control issues, etc.

When compliance tools find an issue with the software commit, the developer receives a notification that the build has failed due to a detected compliance issue. In some examples, the developer manually generates a new software commit to address the non-compliant software commit. To manually generate a new software commit that overcomes the compliance issue while maintaining the same functionality as the original software commit can be difficult for a developer because the developer has to learn and research software databases and libraries that are different than the software databases and libraries they used in the original software commit. This may take a lot of time and knowledge because there is more software than a person (e.g., the developer) could feasibly know. The developer manually generates a new software commit by identifying the source code with a compliance issue, designing a new function that performs the same operation as the software commit without breaking the rules and regulations of the compliance program, and building the new software commit again. In some examples, the second software commit may not build due to another compliance issue or failing to pass the other testing phases.

Apparatus and methods disclosed herein utilize a continuous integration (CI) platform to provide a new software commit to a compliance tool for testing. When the compliance tool notifies the CI platform that an issue in compliance was detected in the software commit, the CI platform queries an example compliance detector to determine if there is a solution to the compliance issue. The compliance detector is implemented by a machine learning model trained to identify defects within source code entities that relate to why the compliance tool detected a compliance issue in the software commit. For example, a model trainer receives software commits, previously identified as non-compliant, as input data and trains a model to identify words, values, phrases, etc. in source code entities that are likely to be defective in software. Further, the model trainer maps the defective source code entities in the software commit to source code entities that are not defective (e.g., solutions).

In some examples, previous solutions may be stored in a database and retrieved by the example compliance detector. If the compliance detector determines a solution or multiple solutions are available, an example suggestion generator provides the top solutions as a suggestion to the developer to fix the software commit with defects corresponding to compliance issues. For example, the suggestion determiner ranks solutions based on a fine-tuning process. The fine-tuning includes a feedback mechanism which provides a first list of solutions to the developer and determines the solution the developer chooses to fix the compliance issue. The chosen solution may be presented first in the suggestion list the next time a software commit includes the same type of compliance issue.

In this manner, examples disclosed herein reduce the number of cycles one software commit goes through to get approved for the project. For example, when a solution for a non-compliant software commit (e.g., a commit with defective source code entities) is found manually, the solution is stored in a database and used by the model trainer. In this manner, when the example compliance detector identifies defects in the source code entities the first time the developer commits the software, the example compliance detector and suggestion generator can utilize the stored solutions to recommend a solution that solves the compliance issue without having to do further testing.

In other examples, apparatus and methods disclosed herein reduce the legal risks and security risks a company may encounter if a developer implements non-compliant software into a system. For example, the compliance detector and suggestion generator generate feedback for low risk and high-quality implementations based on data coming from several sources. Such sources include enterprise repositories utilized for file storage in a company. In this manner, the example compliance detector may access all enterprise repositories of a company to determine potential recommendations for resolving compliance issue. In order to utilize a vast range of data, examples disclosed herein include implementing artificial intelligence (AI) to learn from known software libraries, the software libraries' documentation (e.g., written text or illustration that accompanies software or is embedded in the source code), and other internal repositories. By implementing AI, the developer is no longer required to take additional time and additional cost to design and implement a solution manually.

AI, including machine learning (ML), deep learning (DL), and/or other artificial machine-driven logic, enables machines (e.g., computers, logic circuits, etc.) to use a model to process input data, such as code with compliance issues, to generate an output based on patterns and/or associations previously learned by the model via a training process. For instance, the model may be trained with units of code including compliance issues to recognize patterns in the functions of the code that cause the compliance issue and follow such patterns when processing input data such that other input(s) (e.g., untested code) result in output(s) consistent with the recognized patterns and/or associations.

Many different types of machine learning models and/or machine learning architectures exist. In examples disclosed herein, a Neural Network is used. Using a Neural Network model enables the categorizing and clustering of input data based on recognizing similar patterns. In general, machine learning models/architectures that are suitable to use in the example approaches disclosed herein will be recurrent neural networks (RNN) and Support Vector Machines (SVM). However, other types of machine learning models could additionally or alternatively be used such as deep neural networks (DNN), long short term memory (LSTM), Gated Recurrent Unit (GRU), etc.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a leaning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using gradient descent. However, any other training algorithm may additionally or alternatively be used. In examples disclosed herein, training is performed until an acceptable amount of error is achieved between category predictions. In examples disclosed herein, training is performed at remotely (e.g., at a central facility). Training is performed using hyperparameters that control how the learning is performed (e.g., a learning rate, a number of layers to be used in the machine learning model, etc.). In some examples re-training may be performed. Such re-training may be performed in response to accumulated feedback of the network and further regeneration of an updated network model is to be deployed in place of the old model once the feedback (e.g., variation between actual result and expected result) reaches a threshold.

Training is performed using training data. In examples disclosed herein, the training data originates from locally generated data (e.g., a commit from a developer working on an enterprise project). Because supervised training is used, the training data is labeled. Labeling is applied to the training data by a compliance tool.

Once training is complete, the model is deployed for use as an executable construct that processes an input and provides an output based on the network of nodes and connections defined in the model. The model is stored at an example model publisher. The model may then be executed by the example compliance detector.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

As used herein, the term “software licensing.” “licensing issue,” “licensing,” “license,” etc., is a term used to refer to a legal instrument governing the use or redistribution of software. Under United States copyright law, all software is copyright protected, in both source code and object code forms. The only exception is software in the public domain. A typical software license grants the licensee, typically an end-user, permission to use one or more copies of software in ways where such a use would otherwise potentially constitute copyright infringement of the software owner's exclusive rights under copyright. For example, licensing tools help determine if developers are stealing code.

As used herein, the term “software security,” “security issues,” “security tools,” etc., are terms used to refer to the protection of software against malicious attack and other hacker risks so that software continues to function correctly under such potential risks. Security is necessary to provide integrity, authentication, and availability. In some examples, security tools check to make sure the libraries the developers are using are from a whitelist from the organization, company, enterprise, etc. The whitelist is developed by the organization and includes trusted libraries.

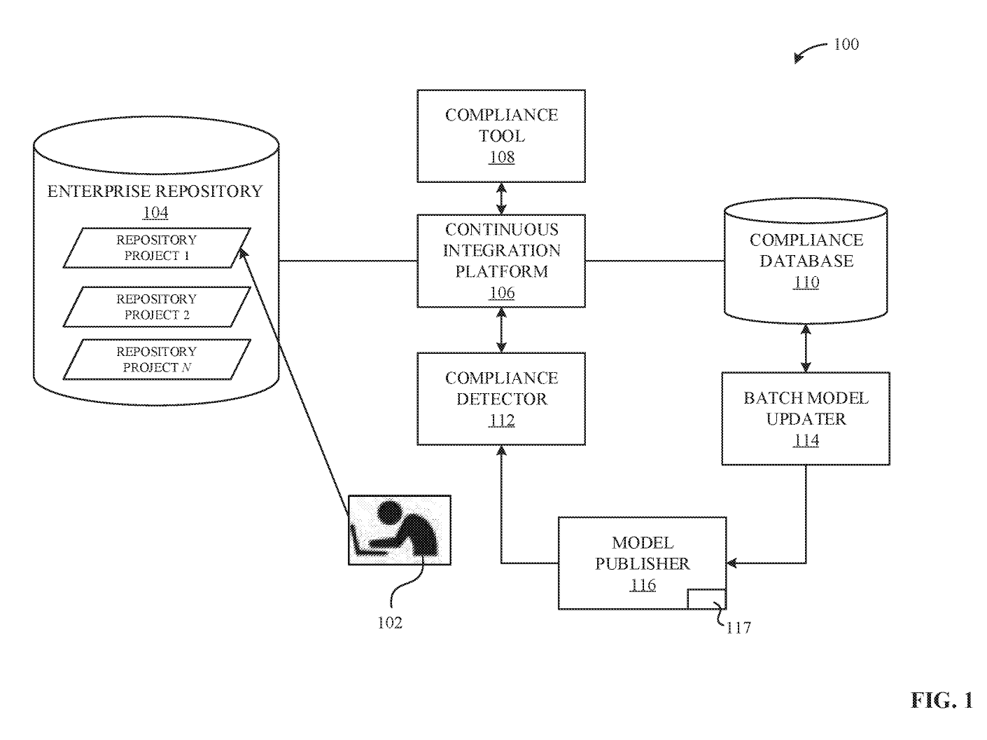

FIG. 1 is a block diagram of a compliance handing system 100 to detect a compliance issue in a software project. The example compliance handling system 100) includes an example developer 102, an example enterprise repository 104, an example CI platform 106, an example compliance tool 108, an example compliance database 110, an example compliance detector 112, an example batch model updater 114, and an example model publisher 116.

In the illustrated example of FIG. 1, the example developer 102 is an employee of company “X” who was tasked with designing software to implement an example project 1. The example developer 102 may be a software engineer, a computer engineer, an information technologist (IT), or any other person capable of designing a new software product for company “X.” The developer 102 may be a plurality of computer engineers designing the software together. The example developer 102 commits a new software which is transmitted to the example enterprise repository 104 for storage and testing.

In the illustrated example of FIG. 1, the example enterprise repository 104 is a database of company “X” to store a plurality of files corresponding to different software projects running at company “X.” For example, the enterprise repository 104 is storage location from which software packages may be retrieved and installed on a computer. In some example, the enterprise repository 104 may house metadata about the packages stored in the repository. The example enterprise repository 104 is used for multiple projects as illustrated. For example, the repository project 1 and repository project 2 may be programs used for different purposes by company “X” or they may be used for the operating system of company “X.” The example enterprise repository 104 may be located locally at company “X” such as in a server. Additionally, the example enterprise repository 104 may be a virtual repository located at a server farm and rented by company “X.”

In the illustrated example of FIG. 1, the example continuous integration platform 106 is in communication with the example enterprise repository 104 to integrate software commits developed by the example developer 102. For example, the CI platform 106 is a tool utilized to retrieve a plurality of software commits (e.g., repo project 1, repo project 2, repo project n) and generate automated builds. The example CI platform 106 generates a build to test the software commits for compliance issues. For example, when the CI platform 106 retrieves a new software commit from the example enterprise repository 104, the CI platform 106 initiates the example compliance tool 108 for execution of a compliance check of the build.

For example, the developer 102 checks out software into their private workspaces. When the example developer 102 is done with their project, they commit the changes to the example enterprise repository 104. The example CI platform 106 monitors the repository and checks out changes when they occur (e.g., when a new software commit has been transmitted to the enterprise repository 104). Then the example CI platform 106 builds the system and runs unit and integration tests. When the build is complete, the example CI platform 106 releases deployable artifacts for testing (e.g., the converted source code). For example, the CI platform 106 provides the build to the compliance tool 108 for testing.

In the illustrated example of FIG. 1, the example compliance tool 108 is a tool utilized to check software commits for compliance issues. The example compliance tool 108 is in communication with the example CI platform 106 to receive a new build and scan the build for licensing issues, security issues, etc. The example compliance tool 108 may be an aggregation of a plurality of compliance tools such as Black Duck Protex IP, Code Center, FlexNet Code, etc. The example compliance tool 108 may utilize any form, type, method, and/or program to check the software commit for compliance issues to report to the CI platform 106 whether the build passes the compliance check or not. In some examples, the compliance tool 108 may detect the use of a library that has been blacklisted by company “X” (e.g., the software is known to have certain security vulnerabilities, small maintainer based with few and/or irregular updates, etc.) and notify the CI platform 106 that the build has failed security compliance check. In other examples, the compliance tool 108 may detect that the software uses source code from libraries that have been put on company “X” whitelist (e.g., the list which includes approved code databases) and the compliance tool 108 notifies the CI platform 106 that the build passes the security compliance check.

The illustrated example of FIG. 1 is provided with the example compliance database 110 to store non-compliant software commits. For example, when the compliance tool 108 detects a compliance issue, the CI platform 106 is notified and the CI platform 106 stores the non-compliant software commit in the compliance database 110. In some examples, the compliance database 110 is utilized to store and map the solutions to the non-compliant software commit. For example, a developer 102 revises source code in the software commit once notified that the build has failed. In this manner, the solution designed by the example developer 102 goes through the testing phases, and if each testing phase determines no errors exist and all compliance is met by the solution, then the solution is stored in the example compliance database 110.

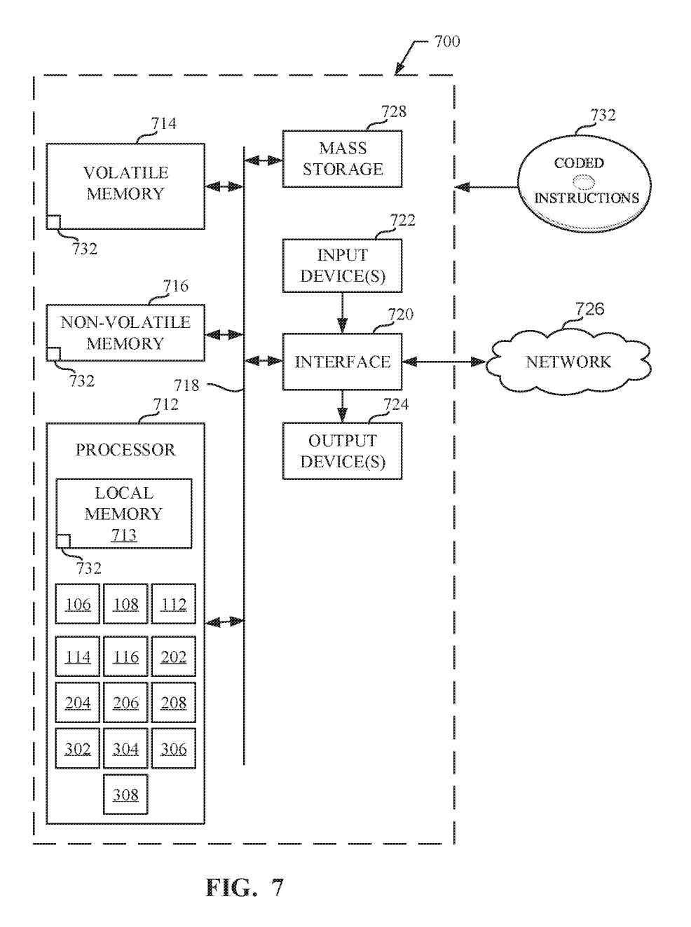

The example compliance database 110 stores training data for the batch model updater 114 and pertinent information for the example compliance detector 112. The example compliance database 110 may be the example non-volatile memory 716 and/or the example local memory 713 of the example processor platform 700 of FIG. 7. Additionally, the example compliance database 110 may be a remote database rented by company “X” or any other type of storage unit in which can be accessed by the example CI platform 106 and the example batch model updater 114.

In the illustrated example of FIG. 1, the example compliance detector 112 is in communication with the CI platform 106 to categorize software into a compliance type and determine potential solutions that would resolve a compliance issue detected in the software. The example compliance detector 112 is triggered by the example CI platform 106 when the example compliance tool 108 detects a compliance issue in software commit. For example, instead of notifying the developer 102 that the build has failed, the CI platform 106 queries the compliance detector 112 for possible solutions. If the example compliance detector 112 generates a suggestions list, then the developer 102 is provided with source code rewritten in a manner that overcomes the compliance issue. By selecting a solution from the suggestions list, the example developer 102 does not need to learn new source code and re-design a new project, hence saving time. If the example compliance detector 112 does not generate a suggestions list, the example CI platform 106 notifies the developer 102 that the build has failed and the developer 102 designs and implements a solution. If the solution is approved after the plurality of testing phases, the solution is stored in the compliance database 110 with reference to the original software commit with non-compliant software.

In subsequent operations, the example compliance detector 112 can utilize the stored solutions as a suggestion the next time a software commit with a similar compliance issue is detected. The example compliance detector 112 can utilize stored solutions for subsequent suggestions by implementing trained models provided the example batch model updater 114. The example compliance detector 112 is described in further detail below in connection with FIG. 3.

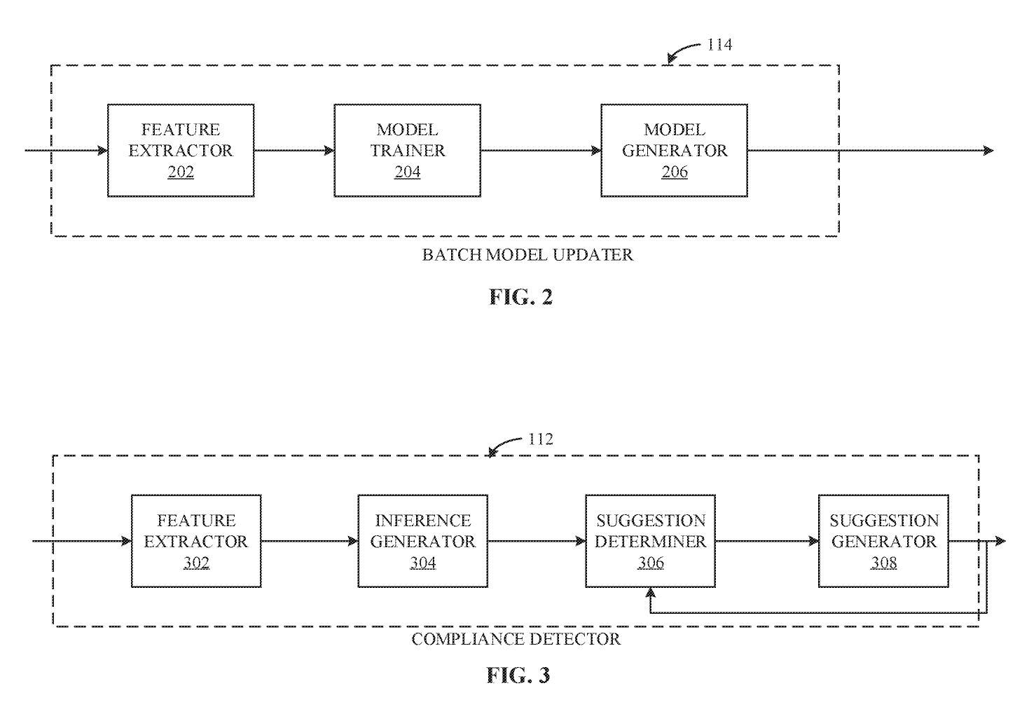

The illustrated example of FIG. 1 is provided with the example batch model updater 114 to generate a model to provide to the compliance detector 112. For example, the batch model updater 114 retrieves software commits from the example compliance database 110 and generates feature vector(s) corresponding to the compliance category (e.g., licensing, security, export control, etc.) and the functions of source code (e.g., semantical properties such as assignments, loops, conditionals, and programming patterns such as behavioral, structural, creational, etc.). The example batch model updater 114 generates an inference (e.g., a conclusion, a classification, a deduction, a prediction) of how the source code is organized and trains a model based on the retrieved software commits. For example, the inference can categorize the software commit or functions of the software commit into a semantical property, a license type, and/or a programming pattern. In this example, the inference may not predict the correct function type the first time the inference is generated. However, the example batch model updater 114 periodically generates new feature vectors and inferences in order to generate precise models that are useful to more accurately confirm and categorize the software commit. The example batch model updater 114 triggers a request for publishing from the example model publisher 116. The batch model updater 114 is further described below in connection with FIG. 2.

The illustrated example of FIG. 1 is provided with the example model publisher 116 to publish the model generated by the batch model updater 114 and provide the model to the example compliance detector 112. For example, the model publisher 116 receives a model from the batch model updater 114 and transforms the model into a consumable format for publishing. As used herein, consumable format is defined as a model that is intended to be used and then replaced (e.g., by an updated model). The model publisher 116 transforms the model into a consumable format to constantly update the compliance detector 112 during the training and detecting phase. In some examples, the model publisher 116 determines if the received model is acceptable to publish. For example, the model publisher 116 may receive a new model that corresponds to a software commit with a licensing compliance issue, but the model publisher 116 may have previously been provided with a model corresponding to a software commit with a licensing compliance issue for which that previous model has not been consumed (e.g., used) by the compliance detector 112. In this example, the model publisher 116 may determine that the new received model cannot be published (e.g., until the previous model is consumed). Other examples in which a model is not acceptable to publish occur when the model publisher 116 is unable to transform the model into a consumable format, and therefore cannot provide the model to the compliance detector 112.

The example model publisher 116 includes a model publisher memory 117 to store the published models corresponding to different compliance issues. For example, the model publisher memory 117 may store a model for a licensing issue that determines the type function corresponding to the licensing issue and can map the predicted function to a known solution stored in the compliance database 110. The example model publisher memory 117 may be queried periodically by the compliance detector 112 for retrieving updated models.

When new software is committed to the enterprise repository 104, a training mode may be initiated based on the output of the compliance detector 112. For example, when the output of a compliance detector 112 is a notification indicating no solutions have been found, the compliance handling system 100 initiates the batch model updater 114 to enter into training mode, and the compliance handling system 100 transmits a plurality of input data (e.g., software commits) to the batch model updater 114 from the compliance database 110 until a model can predict a group of a function with an acceptable amount of error.

FIG. 2 is a block diagram of the example batch model updater 114 to train a model to predict a category of a compliance issue. The example batch model updater 114 includes an example feature extractor 202, an example model trainer 204, and an example model generator 206.

In the illustrated example of FIG. 2, the example batch model updater 114 is provided with the feature extractor 202 to generate a feature vector based on a query for retrieving non-compliant software commits and corresponding solutions (e.g., compliance approved code) from the example compliance database 110. The example feature extractor 202 receives the software commit as a “full unit of code” and parses the full unit of code into an abstract representation. A “full unit of code” is a user defined level of granularity used to analyze the code base. For example, a user can define a full unit of code as function with more than a specific line of source code. An abstract representation of a full unit of code includes generating individual elements from the full unit of code identified as subtrees. A subtree is a portion of a tree data structure that can be viewed as a complete tree in itself. Any node in a tree T, together with all of the nodes below it, comprise a subtree of T. The nodes in a subtree may be connected by an edge to show relationships in between the nodes in a subtree. A subtree is representative of an operator with operands to perform an operation and/or function of the computer program. For example, an algebraic equation, such as 3×5, is an operator where the variable “3” and the variable “5” are operands or an assignment such as x=a+b, where the = is the operator for x and “a” and “b” are operands.

After the example feature extractor 202 parses the full unit of code, the feature extractor 202 may encode the subtrees. As used herein, encoding is the process of putting a sequence of characters (e.g., letters, numbers, punctuation, and certain symbols) into a specialized format for efficient transmission, extraction, or storage. Encoding assists the feature extractor 202 to represent a subtree as a single fixed-length code vector, which can be used to predict semantic properties (e.g., the meaning of the syntactical structure of each line of code) of the subtree to detect words, phrases, values, etc. that are likely to be defective in software. Representing the subtree as a code vector can be performed by decomposing source code to a collection of paths in the source code's abstract representation, and learning the atomic representation (e.g., an unchangeable, irreducible, indivisible, object or unitary action) of each path (e.g., subtree) simultaneously while learning how to aggregate a set of the subtrees. For example, the feature extractor 202 extracts syntactic paths from within a subtree, maps each path to its corresponding real-valued vector representation, then concatenates each vector into a single vector that represents the path context. As used herein, a single fixed-length code vector may be a single string of text representing the highest level of functionality of a subtree. The code vector can be used for various tasks such as extracting features of the code vectors to provide to the example model trainer 204.

In the illustrated example of FIG. 2, the example batch model updater 114 is provided with the example model trainer 204 to train a model based on the output feature vector(s) of the feature extractor 202. The model trainer 204 operates in a training mode where it receives a plurality of pre-identified non-compliant software commits, generates a prediction, and outputs a model based on that prediction. For the example model trainer 204 to generate a model, the model trainer 204 receives feature vectors corresponding to functions of software commits that have been checked by the compliance tool 108 (FIG. 1), identified as having a compliance issue (e.g., licensing problem, security issue, export control issue, etc.) and further mapped to a solution (e.g., a function of code that replaces the non-compliant software commit corresponding to the compliance issue detected). For example, during a training mode, confirmations are made that the solution code units have been approved and implemented in a project so that the data they provide to the batch model updater 114 are suitable for learning. For example, the model trainer 204 receives a feature vector indicative of functions in a non-compliant software commits and associates the function to a code cluster representative of the most optimal solution to utilize for that to the compliance issue. A cluster can be defined depending on compliance type priorities, for example the clusters determine the optimal compliance type to use for the function. For example, the function identified by the model trainer 204 is a function of a commercial project that utilizes the wrong license. In this manner, the example model trainer 204 prioritizes the function into a cluster which determines that license A or license B should be used based on the corresponding solution, but not license C.

The example model trainer 204 groups function of software commits into their corresponding categories based on the prediction made by the model. For example, the model trainer 204 may predict that a feature vector of a software commit is a conditional statement, such as an if-then-else statement which assigns and returns specified values. In this manner, the example model trainer 204 categorizes the predicted conditional statement into an “if-then-else” group. In some examples, the model trainer 204 further groups the function of the source code. For example, the “if-then-else” group includes sub-groups which correspond to the type of value the conditional statement returns. For example, the sub-groups of an “if-then-else” group include condition 1, condition 2, condition n, where condition 1 corresponds to x=a+b, condition 2 corresponds to A>B, and so on. In this manner, the example model trainer 204 generates groups and sub-groups to assist the compliance detector 112 in precisely determining functions of a faulty code unit. The example model trainer 204 may be implemented by an RNN, nonparametric Bayesian methods, and a plurality of other supervised learning algorithms.

In some examples, the compliance database 110 stores software clusters created by the example model trainer 204. The example model trainer 204 utilizes clustering algorithms to create software clusters of the abstracted functions and their corresponding solutions. For example, the model trainer 204 may utilize a combination of multiple types of features extracted from the feature extractor 202 together to apply automated weighing on the extracted features to enhance the features information quality and to reduce noise. The model trainer 204 estimates distance between nodes in terms of a combination of multiple types of features, wherein nodes of a tree or subtree are connected by edges to represent the relationships between nodes in the tree or subtree. The model trainer 204 may utilize weighted graph partitioning with a multi-objective global modularity criterion to select the clusters as architectural components. Weighted graph partitioning is the reduction of a graph (e.g. a tree) to a smaller graph (e.g., a subtree) by partitioning nodes into mutually exclusive groups based on weights of the nodes' edges. Global modularity criterion is the process of selecting a partition (e.g., a subtree) that maximizes the cohesion within the clusters and minimizes the coupling across clusters. The example model trainer 204 maximizes cohesion within clusters to create a well-defined identity of the cluster. For example, a cluster of features represents a similarity between different features of source code, which can be used to predict the type of functions of future source code in non-compliant software commits.

In this manner, the example model trainer 204 trains the model to associate a function and/or a plurality of functions of input data to a cluster and/or a plurality of clusters. For example, the model trainer 204 trains the model to predict a function of extracted features of input data, such as a semantic property of the source code, and then associates the extracted feature with a cluster. The cluster may include source code of multiple different input data that include similar textual features (e.g., similar code comments and identifiers) that may cause the software commit to be non-compliant. The cluster may be labeled with a cluster identifier (e.g., 1−k, where k is the number of clusters generated during the training mode). During the training process, the clusters (e.g., and cluster identifiers) are mapped to a solution and/or solutions with similar features that resolve the compliance issue in the software commit.

In the illustrated example of FIG. 2, the example batch model updater 114 is provided with the example model generator 206 to generate a model for publishing. For example, the model generator 206 may receive a notification from the model trainer 204 that a new and/or updated model has been trained and the model generator 206 may create a file in which the model is published so that the model can be saved and/or stored as the file. In some examples, the model generator 206 provides a notification to the model publisher 116 that a model is ready to be transformed and published.

While an example manner of implementing the batch model updater 114 of FIG. 1 is illustrated in FIG. 2, one or more of the elements, processes and/or devices illustrated in FIG. 2 may be combined, divided, re-arranged, omitted, eliminated and/or implemented in any other way. Further, the example feature extractor 202, the example model trainer 204, the example model generator 206 and/or, more generally, the example batch model updater of FIG. 1 may be implemented by hardware, software, firmware and/or any combination of hardware, software and/or firmware. Thus, for example, any of the example feature extractor 202, the example model trainer 204, the example model generator 206 and/or, more generally, the example batch model updater 114 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example feature extractor 202, the example model trainer 204, and/or the example model generator 206 is/are hereby expressly defined to include a non-transitory computer readable storage device or storage disk such as a memory, a digital versatile disk (DVD), a compact disk (CD), a Blu-ray disk, etc. including the software and/or firmware. Further still, the example batch model updater 114 of FIG. 1 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

FIG. 3 is a block diagram of the example compliance detector 112 of FIG. 1 to detect a type of compliance issue and suggest a method to fix the issue. The example compliance detector 112 includes an example feature extractor 302, an example inference generator 304, an example suggestion determiner 306, and an example suggestion generator 308.

In the illustrated example of FIG. 3, the example compliance detector 112 is provided with the feature extractor 302 to extract features of a software commit provided by the example CI platform 106 when the compliance tool 108 detects a compliance issue in the software commit. For example the feature extractor 302 is provided with a software commit from the example CI platform 106 as a query from the CI platform 106 for potential suggestions to overcome the compliance issue detected in the software commit by the example compliance tool 108. The example feature extractor 302 operates in a manner similar to the feature extractor 202 of FIG. 2. For example, the feature extractor 302 parses the software commit into an abstract representation to further encode and generates a feature vector to be representative of semantical properties and programming patterns of each subtree in the abstract representation. In some examples, the feature vector generated by the feature extractor 302 may be tagged with the compliance issue identified by the example compliance tool 108. For example, the CI platform 106 may provide, in addition to the software commit, the detected compliance issue type (e.g., licensing, security, privacy, etc.). In this manner, the feature vector generated by the example feature extractor 302 may include a label corresponding to a compliance type for simpler matching of functions to solutions.

In the illustrated example of FIG. 3, the example compliance detector 112 is provided with the example inference generator 304 to generate a prediction based on the feature vector provided by the example feature extractor 302. For example, the inference generator 304 may generate a probability value indicative of the likelihood that a function of the software commit is in a specific group representative of a semantical property or programming pattern by utilizing a model that is trained, generated, and published by the example batch model updater 114 and the example model publisher 116 of FIG. 1. For example, the published model may have the ability to predict a group (e.g., a conditional statement group, a loop group, a structural pattern group, etc.) for any subtree represented in the abstract representation of the software commit.

In some examples, the inference generator 304 associates the predicted function with a cluster. For example, a cluster of the multiple clusters generated by the model trainer 204 of FIG. 2 is representative of a function type (e.g., semantic properties) and a compliance type (e.g., a license), and further determines optimal compliance types the developer 102 can utilize to resolve the compliance issue. For example, the inference generator 304 may assign, based on the predicted group of the function, a cluster identifier to the function of the software commit. In this manner, the example inference generator 304 can determine the functions to retrieve from the example compliance database 110.

For example, the inference generator 304 associates the function with a cluster identifier and further queries the compliance database 110 for solutions mapped to the determined cluster identifier. In this manner, the inference generator 304 provides the retrieved solutions from the example compliance database 110 to the example suggestion determiner 306 for further processing of solutions and non-compliant code.

The illustrated example of FIG. 3 is provided with the example suggestion determiner 306 to build a pool of suggestions based on the corresponding cluster. For example, the suggestions determiner 306 receives the cluster of functions and their corresponding solutions and analyzes the solutions based on a plurality of factors before suggesting the stored solutions to the developer 102. In some examples, the suggestion determiner 306 is a recommender model that can be implemented as a content-based filtering model. A recommender model is a model that guides users (e.g., the developer 102) in a personalized way to interesting objects in a large space of possible options. Content-based recommendation models recommend items similar to those a given user has liked in the past (e.g., preferred solutions to certain compliance issues). For example, an online retailer store may utilize recommendation algorithms to personalize the online store for each customer such as showing programming titles to a software engineer and baby toys to a new mother.

The example suggestion determiner 306 may analyze the historical preferences of the example developer 102 or any employee of company “X” received by a feedback loop from the output of the example suggestion generator 308. For example, when a developer 102 chooses an example solution A more times than they choose an example solution B, the example suggestion determiner 306 extracts this information to be learned by a model. The output of the model may be a prediction based on the likelihood that the developer 102 picks one compliance type over the other, the developer 102 is more familiar with one programming language over the other, etc. The example suggestion determiner 306 further exploits the user profile (e.g., the learned model) to suggest relevant solutions by matching the profile representation against that of the solutions provided by the example inference generator 304. In some examples, the suggestion determiner 306 takes into account history of solutions accepted by developers (e.g., the developer 102), similarity of the input data with the pool of suggestions, and compliance type friendly (e.g., is the solution license friendly).

For example, the suggestion determiner 306 makes a comparison of similarity between the input data and the retrieved solutions. The example suggestion determiner 306 compares the abstracted function of the software commit with functions presented in the retrieved solutions. The example suggestion determiner 306 may analyze the functions based on a bigram string similarity measure. The bigram string similarity first determines labels (l) and values (v) for each node n in a subtree of the faulty function and an approved function. After the bigram string similarity analyzes the labels and value for each node in a subtree, the bigram string similarity detects changes between two subtrees (e.g., faulty function and at least one of the approved functions) based on labels, l, and values, v, of each node in the subtrees and calculates a distance score for each approved function to the faulty function. For example bigram compares two or more strings of text, such as label names, and generates a score based on the difference between the strings of text. In one example, the bigram string similarity algorithm compares groupings of two letters per string of text, such as “th” “wr” “em,” etc., and based on the frequency the groupings occur in each text, compute a distance score. For example, “loop” and “if” compute a distance score of 3, because there are three groupings of two letters, “lo,” “oo,” and “op,” and the string “if” will need to change all three groups to become “loop.” Additionally, the example suggestion determiner 306 may utilize any algorithm to compare approved functions to the faulty function to detect which approved function is most similar to that of the faulty function.

In this manner, the suggestion determiner 306 eliminates an abundance of information provided by repositories with solutions by fine-tuning the solutions. For example, the suggestion determiner 306 may not need to sift through a plurality of solutions in the retrieved cluster and further analyze the clusters to present only the top solutions (e.g., 10 solutions) out of many (e.g., hundreds of solutions) due to the learned model which takes into account a preference of a user and a profile of the user.

The example compliance detector 112 is provided with the example suggestion generator 308 to create a suggestion report and provide the report to a user interface for a programmer, developer, etc., to view. For example, the report may include a list, in ascending order, of functions that can be utilized to fix, replace, and/or update the corresponding function of the software commit that was detected as including a compliance issue. In this example, the developer 102 may select one of the solutions suggested in the suggestion report and apply the fix to unit code. In other examples, the suggestion generator 308 may provide the suggestion report to the CI platform 106 to pick a solution and apply the solution to the code unit being tested.

When the example suggestion generator 308 presents the top suggestions to the example developer 102 and the developer 102 chooses a solution, a feedback loop informs the example suggestion determiner 306 of the chosen solution for fine-tuning of the content-based recommendation model in the example suggestion determiner 306.

While an example manner of implementing the compliance detector 112 of FIG. 1 is illustrated in FIG. 3, one or more of the elements, processes and/or devices illustrated in FIG. 3 may be combined, divided, re-arranged, omitted, eliminated and/or implemented in any other way. Further, the example feature extractor 302, the example inference generator 304, the example suggestion determiner 306, the example suggestion generator 308 and/or, more generally, the example batch model updater of FIG. 1 may be implemented by hardware, software, firmware and/or any combination of hardware, software and/or firmware. Thus, for example, any of the example feature extractor 302, the example inference generator 304, the example suggestion determiner 306, the example suggestion generator 308 and/or, more generally, the example compliance detector 112 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example feature extractor 302, the example inference generator 304, the example suggestion determiner 306, and/or the example suggestion generator 308 is/are hereby expressly defined to include a non-transitory computer readable storage device or storage disk such as a memory, a digital versatile disk (DVD), a compact disk (CD), a Blu-ray disk, etc. including the software and/or firmware. Further still, the example compliance detector 112 of FIG. 1 may include one or more elements, processes and/or devices in addition to, or instead of, those illustrated in FIG. 3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

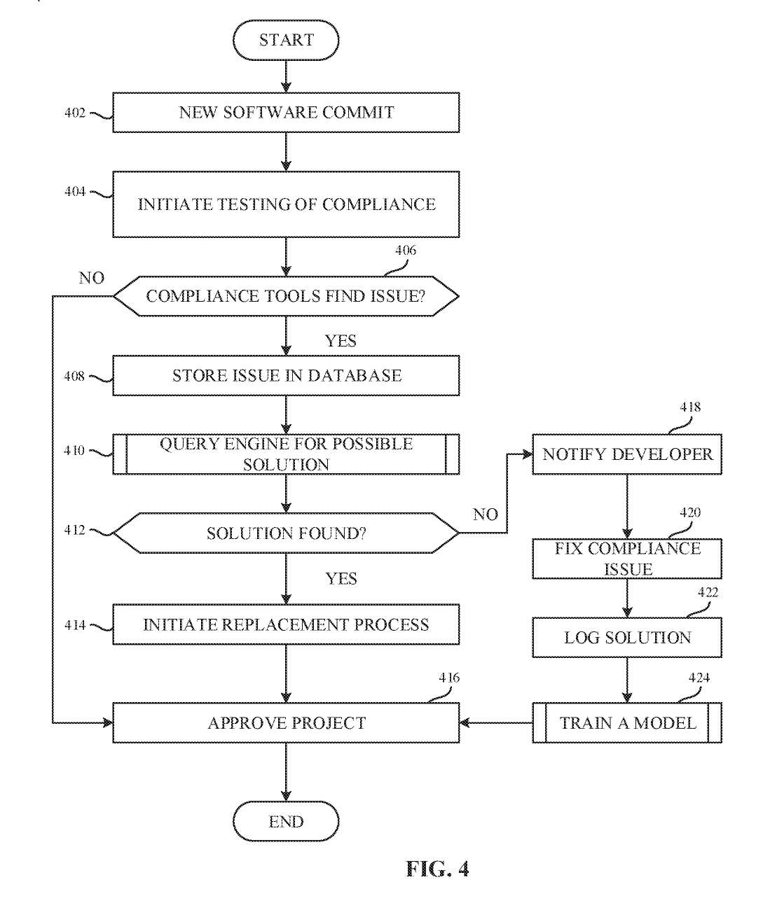

A flowchart representative of example hardware logic, machine readable instructions, hardware implemented state machines, and/or any combination thereof for implementing the compliance handling system 100, the batch model updater 114, and the compliance detector 112 of FIG. 1 is shown in FIGS. 4, 5, and 6. The machine readable instructions may be one or more executable programs or portion(s) of an executable program for execution by a computer processor such as the processor 712 shown in the example processor platform 700 discussed below in connection with FIG. 7. The program may be embodied in software stored on a non-transitory computer readable storage medium such as a CD-ROM, a floppy disk, a hard drive, a DVD, a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowcharts illustrated in FIGS. 4, 5, and 6, many other methods of implementing the example compliance handling system 100, the example batch model updater 114, and the example compliance detector 112 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, etc. in order to make them directly readable and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein. In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

As mentioned above, the example processes of FIGS. 4, 5, and 6 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

The program of FIG. 4 begins at block 402 when the example developer commits a new project. For example, the enterprise repository 104 receives and stores software commits from the developer 102 for testing and implementation into a system. The example CI platform 106 periodically queries the enterprise repository 104 for new software commits that should be integrated and tested for the system. When the example CI platform 106 retrieves software commits from the example enterprise repository 104, the CI platform 106 initiates testing of the compliance of the retrieved commits. (Block 404). For example, the CI platform 106 provides the example compliance tool 108 with new software commit to detect compliance issues.

The example CI platform 106 determines if the compliance tool 108 detects a compliance issue. (Block 406). For example, if the compliance tool 108 provides a notification indicating the software commits did meet compliance rules and regulations (e.g., Block 406 returns a NO), the example CI platform 106 approves the project for compliance and the program of FIG. 4 ends. If the compliance tool 108 provides a notification indicating the software commit did not meet compliance regulations and rules (e.g., Block 406 returns a YES), the CI platform 106 stores the non-compliant software commit in the example compliance database 110. (Block 408). For example, the non-compliant software commit and the corresponding compliance type are mapped/linked together in the example compliance database 110 for subsequent processing.

Additionally, the example CI platform 106 queries the example compliance detector 112 for possible solutions (block 410) to update the non-compliant software commit to a function that meets compliance regulations. For example, the CI platform 106 is in communication with the example compliance detector 112 to find solutions the developer 102 can utilize in a timely manner. The example CI platform 106 determines if the compliance detector 112 found a solution (block 412). For example, if the example compliance detector 112 outputs a suggestion report to the CI platform 106 or a user interface operated by the developer 102 (e.g., Block 412 returns a YES), then the example CI platform 106 initiates a replacement process. For example the developer 102 may choose a solution, implement the solution in the project, and recommit the software to the enterprise repository for integration and testing. In this manner, the example CI platform 106 may approve the project (block 416) for compliance check and the program of FIG. 4 ends.

If the example compliance detector 112 does not output a suggestion report (e.g., Block 412 returns a NO), the developer is notified. (Block 418). For example, the CI platform 106 may notify the developer 102 via a user interface that the project was non-compliant and no solutions were found. In this manner, the example developer 102 manually fixes the compliance issue. (Block 420). For example, the developer 102 learns, designs, and implements a new program that is, hopefully, compliant. The CI platform 106 receives the new program and logs the solution. (Block 422). For example, the CI platform 106 stores the solution generated by the example developer 102 into the compliance database 110 to be mapped to the non-complaint software and compliance issue for subsequent training by the example batch model updater 114.

When the example CI platform 106 logs the solution, the example batch model updater 114 may be initiated to train a model. (Block 424). For example, the non-complaint software is used as input data to train a model based on features in the input data, such as snippets of code that include features which do not meet rules and regulations set forth by an organization, the government, etc.

The program of FIG. 4 ends when the example CI platform 106 approves the new project (block 416). The program of FIG. 4 may be repeated when a developer 102 commits a new project and the example CI platform 106 retrieves the new project for compliance testing.

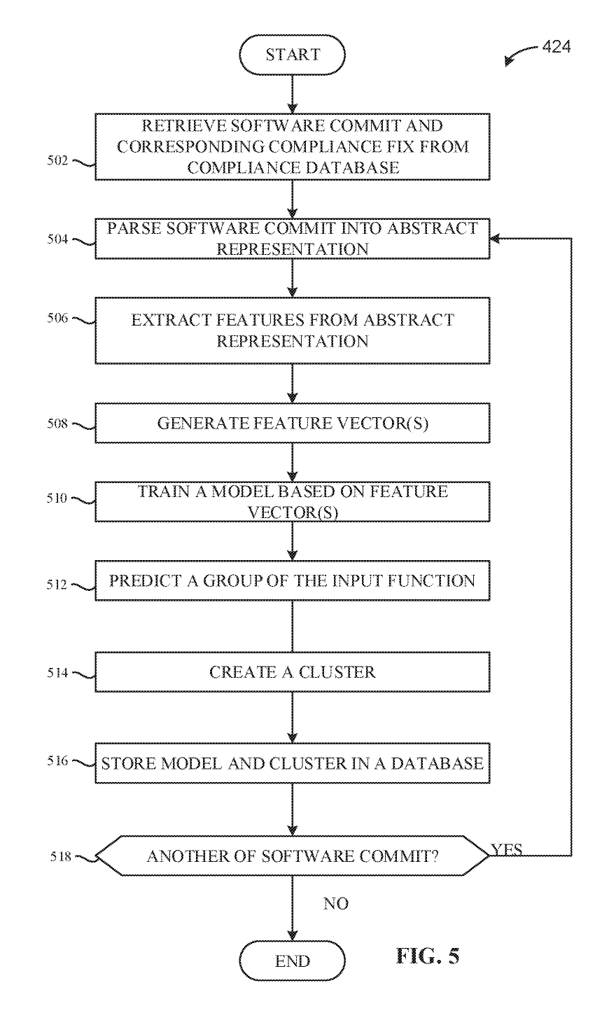

The training program of FIG. 5 corresponds to an operation of the example batch model updater 114 of FIGS. 1 and 2. The training program of FIG. 5 is initiated when the example batch model updater 114 is notified to train a model based on the software commit stored in the example compliance database 110. For example, when the developer 102 commits a solution to a non-compliant project, the example batch model updater 114 is triggered to begin the training of a model to predict a function of software commit and map the function to a solution. The training program of FIG. 5 beings when the example feature extractor 202 (FIG. 2) retrieves a software commits and corresponding solution from the example compliance database 110. (Block 502).

The example feature extractor 202 parses the software into an abstract representation. (Block 504). For example, the feature extractor 202 utilizes a parser, such as a compiler or interpreter, to break data down into smaller elements for simple translation by forming subtrees of nodes. The example feature extractor 202 then extracts features from the abstract representation of the software. (Block 506). For example, the feature extractor 202 extracts syntactic paths from within a code snippet (e.g., a subtree), maps each path to its corresponding real-valued vector representation indicative of a semantic property of the code, then concatenates each vector into a single vector that represents the path context.

The example feature extractor 202 generates feature vector(s) (block 508) to provide to the example model trainer 204. For example, the feature vectors may be the code vectors indicative of semantic features or programming pattern features of the function of software commits. In some examples, the feature vectors include descriptive information corresponding to a function of the software commits. The example model trainer 204 trains a model based on the feature vectors (block 510) provided by the example feature extractor 202. For example, a RNN is trained to make predictions based on input feature vectors. The example model trainer 204 predicts a group in which the input function resides. (Block 512). For example, the model trainer 204 categorizes the function into a group name such as “conditional statement group,” “loop group,” “behavioral group,” etc.

The example model trainer 204 further creates a cluster (block 514) for a plurality of functions categorized into a group. For example, a cluster identifies multiple functions of similar type with their corresponding compliance issue and solution. The example model generator 206 stores the trained model and cluster(s) in a database (e.g., the compliance database 110, the model publisher memory 117, the example enterprise repository 104, etc.). (Block 516). For example, the model generator 206 receives the trained model and transforms the model into a file for publishing. Additionally, the example model generator 206 stores the clusters generated by the example model trainer 204 in a database.

The example feature extractor 202 determines if another software commit is stored (Block 518) that can be utilized for training purposes of the batch model updater 114. For example, when a developer 102 commits one or more software (e.g., Block 518 returns a YES), the training program of FIG. 5 restarts so that each project can be utilized to train a model if the project includes a compliance issue and a solution. If there is not another software commit to be analyzed (e.g., Block 518 returns a NO), the program of FIG. 5 ends.

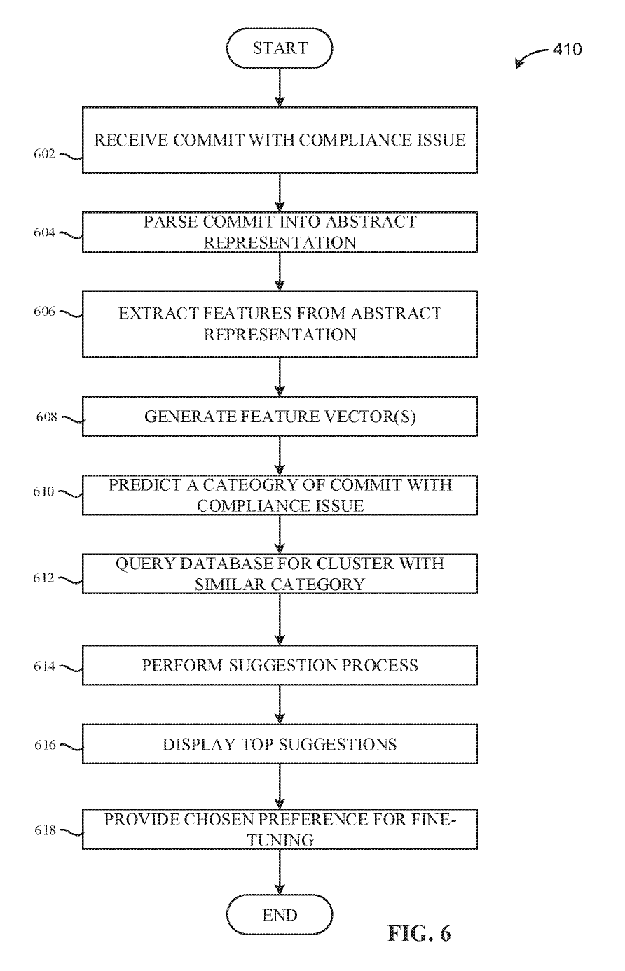

The inference program of FIG. 6 corresponds to an operation of the example compliance detector 112 of FIGS. 1 and 3. The inference program of FIG. 6 begins when the example feature extractor 302 receives a commit with a compliance issue. (Block 602). For example, the CI platform 106 is notified by the example compliance tool 108 when a commit does not pass a compliance check and provides it to the compliance detector 112 to determine potential solutions.

The example feature extractor 302 parses the commit into an abstract representation. (Block 604). For example, the feature extractor 302 utilizes a compiler or interpreter to break down the commit into smaller elements (e.g., subtrees, functions, etc.) for simple processing and feature extraction. The example feature extractor 302 extracts features of the parsed emmit. (Block 606). For example, the feature extractor 302 identifies semantic properties of each function and generates a code vector to represent the function.

The example feature extractor 302 generates feature vectors based on the extracted features of the parsed code. (Block 608). For example, the extracted features may include strings of test or labels corresponding to functions of software commits, programming languages, programming patterns, etc. The example feature extractor 302 provides the feature vectors to the published model in the example inference generator 304. For example, the inference generator 304 periodically receives updated models from the example model generator 206.

The example inference generator 304 predicts a category of the commit with a compliance issue. (Block 610). For example, the inference generator 304 groups functions of the commit into groups to be assigned a cluster identifier. The groups are indicative of the type of function(s) in the commit with the compliance issue. Depending on the group the function resides in and the compliance issue of the commit, a cluster identifier is assigned to the commit by the example inference generator 304.

The example inference generator 304 queries a database (e.g., the compliance database 110, the model publisher memory 117, or the enterprise repository 104), for the cluster corresponding to the assigned cluster identifier. (Block 612). For example, the inference generator 304 retrieves the solutions mapped to the clusters for analysis by the example suggestion determiner 306.

The example suggestion determiner 306 performs the suggestion process. (Block 614). For example, the suggestion determiner 306 gathers profile data corresponding to the developer 102 (e.g., preferences, historical solutions utilized, etc.) and learns a model that filters input data (e.g., solutions to a compliance issue in a new commit) based on the profile of the developer 102, similarity of software commits to the suggested solutions, and compliance friendly. The example suggestion determiner 306 uses the learned model to exploit the user profile to suggest relevant solutions by matching the profile representation and non-compliant software commit against that of solutions to be recommended.

The example suggestion determiner 306 provides a list of suggestions to the example suggestion generator 308 to generate a suggestion report and display the top suggestions to the developer 102. (Block 616). For example, the top suggestions include the solutions that are most heavily weighted based on user preferences and software commit similarity. When the example developer 102 chooses a solution from the generated suggestion report, the example chosen solution is fed back to the example suggestion determiner 306 for fine-tuning of the content-based recommender system. (Block 618). For example, the feedback provides additional data the example suggestion determiner 306 can utilize to build the user profile.

The inference program of FIG. 6 ends when the developer 102 chooses a solution to implement into their project. The inference program of FIG. 6 may be repeated when the example CI platform 106 receives a notification from the compliance tool 108 that a compliance issue has been detected in a new project commit.

FIG. 7 is a block diagram of an example processor platform 700 structured to execute the instructions of FIGS. 4, 5, and 6 to implement the example compliance handling system 100, the example batch model updater 114, and the example compliance detector of FIG. 1. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example CI platform 106, the example compliance tool 108, the example compliance detector 112, the example batch model updater 114, and the example model publisher 116.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), a Bluetooth®) interface, a near field communication (NFC) interface, and/or a PCI express interface.

In the illustrated example, one or more input devices 722 are connected to the interface circuit 720. The input device(s) 722 permit(s) a user to enter data and/or commands into the processor 712. The input device(s) can be implemented by, for example, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives.

The machine executable instructions 732 of FIGS. 4, 5, and 6 may be stored in the mass storage device 728, in the volatile memory 714, in the non-volatile memory 716, and/or on a removable non-transitory computer readable storage medium such as a CD or DVD.

Example methods, apparatus, systems, and articles of manufacture to resolve compliance issues are disclosed herein. Further examples and combinations thereof include the following: Example 1 includes an apparatus for detecting a compliance issue comprising a feature extractor to extract a plurality of features from input data corresponding to the compliance issue and the plurality of features including descriptive information corresponding to a function of the input data, an inference generator to classify the plurality of features into a group indicative of at least one of a semantic property, a programming pattern, or a compliance type of the function of the input data, assign a cluster identifier to the plurality of features based on a prediction that the plurality of features are classified into the group, and retrieve a solution from a database that correspond to the cluster identifier, the solution to resolve the compliance issue corresponding to the input data, and a suggestion determiner to generate a suggestions list to present to a user by building a pool of solutions.

Example 2 includes the apparatus of example 1, wherein the inference generator includes a model to classify the plurality of features into the group.

Example 3 includes the apparatus of example 2, wherein the model is trained to identify patterns in properties of features to classify the input data into the group.

Example 4 includes the apparatus of example 1, further including a batch model updater to train a model to predict a function of input data representative of a compliance issue and generate a cluster of similar input data with similar compliance issues, the batch model updater to associate the cluster of similar input data to a solution of the compliance issue represented in the input data.

Example 5 includes the apparatus of example 1, further including a model publisher to transform a model trained by a batch model updater into a file to be provided to a compliance detector for classifying input data into groups corresponding to at least one of the semantic property, programming pattern, or compliance type.

Example 6 includes the apparatus of example 1, wherein the input data is a unit of code, a software commit, or a portion of code.

Example 7 includes the apparatus of example 1, wherein the suggestion determiner is to build the pool of solutions based on i) a comparison of similarity between the plurality of features corresponding to the input data and the solution, ii) a profile of the user, and iii) a compliance type corresponding to a solution that meets a compliance standard.

Example 8 includes the apparatus of example 7, wherein the profile of the user includes historical preferences of the user determined by a feedback of historically chosen solutions.

Example 9 includes a non-transitory computer readable storage medium comprising instructions that, when executed, cause a processor to at least extract a plurality of features from input data corresponding to a compliance issue and the plurality of features including descriptive information corresponding to a function of the input data, classify the plurality of features into a group indicative of at least one of a semantic property, a programming pattern, or a compliance type of the function of the input data, assign a cluster identifier to the plurality of features based on a prediction that the plurality of features are classified into the group, retrieve a solution from a database that corresponds to the cluster identifier, the solution to resolve the compliance issue corresponding to the input data, and generate a suggestions list to present to a user by building a pool of solutions.

Example 10 includes the non-transitory computer readable storage medium as defined in example 9, wherein the instructions, when executed, cause the processor to classify the plurality of features into the group based on a model.

Example 11 includes the non-transitory computer readable storage medium as defined in example 10, wherein the instructions, when executed, cause the processor to train the model to identify patterns in properties of features to classify the input data into the group.

Example 12 includes the non-transitory computer readable storage medium as defined in example 9, wherein the instructions, when executed, cause the processor to train a model to predict a function of input data representative of a compliance issue and generate a cluster of similar input data with similar compliance issues, the processor to associate the cluster of similar input data to a solution of the compliance issue represented in the input data.

Example 13 includes the non-transitory computer readable storage medium as defined in example 9, wherein the instructions, when executed, cause the processor to transform a trained model into a file to classify input data into groups corresponding to at least one of the semantic property, programming pattern, or compliance type.

Example 14 includes the non-transitory computer readable storage medium as defined in example 9, wherein the instructions, when executed, cause the processor to build the pool of solutions based on i) a comparison of similarity between the plurality of features corresponding to the input data and the solution, ii) a profile of the user, and iii) a compliance type corresponding to a solution that meets a compliance standard.

Example 15 includes the non-transitory computer readable storage medium as defined in example 14, wherein the instructions, when executed, cause the processor to determine the profile of the user based on historical preferences of the user determined by a feedback of historically chosen solutions.

Example 16 includes a method comprising extracting a plurality of features from input data corresponding to a compliance issue and the plurality of features including descriptive information corresponding to a function of the input data, classifying the plurality of features into a group indicative of at least one of a semantic property, a programming pattern, or a compliance type of the function of the input data, assigning a cluster identifier to the plurality of features based on a prediction that the plurality of features are classified into the group, retrieving a solution from a database that corresponds to the cluster identifier, the solution to resolve the compliance issue corresponding to the input data, and generating a suggestions list by building a pool of solutions.

Example 17 includes the method of example 16, further including classifying the plurality of features into the group based on a model.

Example 18 includes the method of example 17, further including training the model to identify patterns in properties of features to classify the input data into the group.

Example 19 includes the method of example 16, further including training a model to predict a function of input data representative of a compliance issue and generating a cluster of similar input data with similar compliance issues, the method to associate the cluster of similar input data to a solution of the compliance issue represented in the input data.

Example 20 includes the method of example 16, wherein building the pool of solutions is based on i) a comparison of similarity between the plurality of features corresponding to the input data and the solution, ii) a profile of a user including historical preferences of the user determined by a feedback of historically chosen solutions, and iii) a compliance type corresponding to a solution that meets a compliance standard.

Example 21 includes an apparatus to detect a compliance issue, the apparatus comprising a means for extracting, the means for extracting to extract a plurality of features from input data corresponding to the compliance issue and the plurality of features including descriptive information corresponding to a function of the input data, a means for generating, the means for generating to classify the plurality of features into a group indicative of at least one of a semantic property, a programming pattern, or a compliance type of the function of the input data, assign a cluster identifier to the plurality of features based on a prediction that the plurality of features are classified into the group, and retrieve a solution from a database that corresponds to the cluster identifier, the solution to resolve the compliance issue corresponding to the input data, and a means for creating, the means for creating to create a suggestions list to present to a user based on a building of a pool of solutions. The example means for extracting may be implemented by the example feature extractor 302 of FIG. 3. The example first means for generating may be implemented by the example inference generator 304 of FIG. 3. The example means for creating may be implemented by the example suggestion generator 308 of FIG. 3.

Example 22 includes the apparatus of example 21, further including a means for training, the means for training are to generate a model to classify the plurality of features into the group. The example means for training may be implementing by the example model trainer 204 of FIG. 2.

Example 23 includes the apparatus of example 22, wherein the means for training are to train the model to identify patterns in properties of features to classify the input data into the group.

Example 24 includes the apparatus of example 21, further including a means for building, the means for building to build the pool of solutions based on i) a comparison of similarity between the plurality of features corresponding to the input data and the solution, ii) a profile of the user, and iii) a compliance type corresponding to a solution that meets a compliance standard. The means for building may be implemented by the example suggestion determiner 306 of FIG. 3.

Example 25 includes the apparatus of example 24, wherein the means for building are to generate the profile of the user based on a feedback of historically chosen solutions of the user.

From the foregoing, it will be appreciated that example methods, apparatus and articles of manufacture have been disclosed that generate a suggestion pool of solutions to present to a developer who has committed a project with non-compliant code. The disclosed methods, apparatus and articles of manufacture improve the efficiency of using a computing device by reducing processing time it takes for a compliance handling system to test and integrate commits. The disclosed methods, apparatus and articles of manufacture are accordingly directed to one or more improvement(s) in the functioning of a computer. Additionally, examples disclosed herein reduce the time it takes a developer to complete a new project, reduce the risk of approving non-compliant code for a project, improves software security and robustness by ensuring approved software libraries are used, and reduces the amount of information to be processed according to preferences and profiles for a numerous amount of possible suggestions.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus for detecting a compliance issue comprising:
a feature extractor to extract a plurality of features from input data corresponding to the compliance issue and the plurality of features including descriptive information corresponding to a function of the input data;
an inference generator to:
classify the plurality of features into a group indicative of at least one of a semantic property, a programming pattern, or a compliance type of the function of the input data;
assign a cluster identifier to the plurality of features based on a prediction that the plurality of features are classified into the group; and
retrieve a solution from a database that correspond to the cluster identifier, the solution to resolve the compliance issue corresponding to the input data; and
a suggestion generator to generate a suggestions list to present to a user based on a building of a pool of solutions.

2. The apparatus of claim 1, wherein the inference generator includes a model to classify the plurality of features into the group.

3. The apparatus of claim 2, wherein the model is trained to identify patterns in properties of features to classify the input data into the group.

4. The apparatus of claim 1, further including a batch model updater to train a model to predict a function of input data representative of a compliance issue and generate a cluster of similar input data with similar compliance issues, the batch model updater to associate the cluster of similar input data to a solution of the compliance issue represented in the input data.

5. The apparatus of claim 1, further including a model publisher to transform a model trained by a batch model updater into a file to be provided to a compliance detector for classifying input data into groups corresponding to at least one of the semantic property, programming pattern, or compliance type.

6. The apparatus of claim 1, wherein the input data is a unit of code, a software commit, or a portion of code.

7. The apparatus of claim 1, further including a suggestion determiner to build the pool of solutions based on i) a comparison of similarity between the plurality of features corresponding to the input data and the solution, ii) a profile of the user, and iii) a compliance type corresponding to a solution that meets a compliance standard.

8. The apparatus of claim 7, wherein the profile of the user includes historical preferences of the user determined by a feedback of historically chosen solutions.

9. A non-transitory computer readable storage medium comprising instructions that, when executed, cause a processor to at least:
extract a plurality of features from input data corresponding to a compliance issue and the plurality of features including descriptive information corresponding to a function of the input data;
classify the plurality of features into a group indicative of at least one of a semantic property, a programming pattern, or a compliance type of the function of the input data;
assign a cluster identifier to the plurality of features based on a prediction that the plurality of features are classified into the group;
retrieve a solution from a database that corresponds to the cluster identifier, the solution to resolve the compliance issue corresponding to the input data; and
generate a suggestions list to present to a user based on a building of a pool of solutions.

10. The non-transitory computer readable storage medium as defined in claim 9, wherein the instructions, when executed, cause the processor to classify the plurality of features into the group based on a model.

11. The non-transitory computer readable storage medium as defined in claim 10, wherein the instructions, when executed, cause the processor to train the model to identify patterns in properties of features to classify the input data into the group.

12. The non-transitory computer readable storage medium as defined in claim 9, wherein the instructions, when executed, cause the processor to train a model to predict a function of input data representative of a compliance issue and generate a cluster of similar input data with similar compliance issues, the processor to associate the cluster of similar input data to a solution of the compliance issue represented in the input data.

13. The non-transitory computer readable storage medium as defined in claim 9, wherein the instructions, when executed, cause the processor to transform a trained model into a file to classify input data into groups corresponding to at least one of the semantic property, programming pattern, or compliance type.

14. The non-transitory computer readable storage medium as defined in claim 9, wherein the instructions, when executed, cause the processor to build the pool of solutions based on i) a comparison of similarity between the plurality of features corresponding to the input data and the solution, ii) a profile of the user, and iii) a compliance type corresponding to a solution that meets a compliance standard.

15. The non-transitory computer readable storage medium as defined in claim 14, wherein the instructions, when executed, cause the processor to determine the profile of the user based on historical preferences of the user determined by a feedback of historically chosen solutions.

16. A method comprising:
extracting a plurality of features from input data corresponding to a compliance issue and the plurality of features including descriptive information corresponding to a function of the input data;
classifying the plurality of features into a group indicative of at least one of a semantic property, a programming pattern, or a compliance type of the function of the input data;
assigning a cluster identifier to the plurality of features based on a prediction that the plurality of features are classified into the group;
retrieving a solution from a database that corresponds to the cluster identifier, the solution to resolve the compliance issue corresponding to the input data; and
generating a suggestions list based on a building of a pool of solutions.

17. The method of claim 16, further including classifying the plurality of features into the group based on a model.

18. The method of claim 17, further including training the model to identify patterns in properties of features to classify the input data into the group.

19. The method of claim 16, further including training a model to predict a function of input data representative of a compliance issue and generating a cluster of similar input data with similar compliance issues, the method to associate the cluster of similar input data to a solution of the compliance issue represented in the input data.

20. The method of claim 16, wherein building the pool of solutions is based on i) a comparison of similarity between the plurality of features corresponding to the input data and the solution, ii) a profile of a user including historical preferences of the user determined by a feedback of historically chosen solutions, and iii) a compliance type corresponding to a solution that meets a compliance standard.

21. An apparatus to detect a compliance issue, the apparatus comprising:
a means for extracting, the means for extracting to extract a plurality of features from input data corresponding to the compliance issue and the plurality of features including descriptive information corresponding to a function of the input data;
a means for generating, the means for generating to:
classify the plurality of features into a group indicative of at least one of a semantic property, a programming pattern, or a compliance type of the function of the input data;
assign a cluster identifier to the plurality of features based on a prediction that the plurality of features are classified into the group; and
retrieve a solution from a database that corresponds to the cluster identifier, the solution to resolve the compliance issue corresponding to the input data; and
a means for creating, the means for creating to create a suggestions list to present to a user based on a building of a pool of solutions.

22. The apparatus of claim 21, further including a means for training, the means for training are to generate a model to classify the plurality of features into the group.

23. The apparatus of claim 22, wherein the means for training are to train the model to identify patterns in properties of features to classify the input data into the group.

24. The apparatus of claim 21, further including a means for building, the means for building to build the pool of solutions based on i) a comparison of similarity between the plurality of features corresponding to the input data and the solution, ii) a profile of the user, and iii) a compliance type corresponding to a solution that meets a compliance standard.

25. The apparatus of claim 24, wherein the means for building are to generate the profile of the user based on a feedback of historically chosen solutions of the user.
